(19) United States
(12) Patent Application Publication
(10) Pub. No.: US 2014/0293892 A1
(43) Pub. Date: Oct. 2, 2014

(54) WIRELESS SIGNAL RECEIVER AND ASSOCIATED SIGNAL PROCESSING METHOD

(71) Applicant: MStar Semiconductor, Inc., Hsinchu Hsien (TW)

(72) Inventors: Teng-Han Tsai, Zhubei City (TW); Tai-Lai Tung, Zhubei City (TW)

(73) Assignee: MStar Semiconductor, Inc., Hsinchu Hsien (TW)

(21) Appl. No.: 14/221,399

(22) Filed: Mar. 21, 2014

(30) Foreign Application Priority Data
Mar. 29, 2013 (TW) 102111496

(51) Int. Cl. H04W 72/04

(52) U.S. Cl. CPC H04W 72/0473
USPC 370/329

(57) ABSTRACT

A wireless signal receiver includes a receiving module, an automatic gain control (AGC) module, a measuring module, a decoding module, and a control module. The receiving module receives a wireless signal. The AGC module adjusts an amplitude of the wireless signal according to a gain to generate an adjusted signal. The measuring module measures a signal strength of the adjusted signal. The decoding module decodes the adjusted signal. When the decoding module determines that the adjusted signal corresponds to a beacon packet transmitted from a transmitting end, the control module adjusts the gain according to the signal strength.

This application claims the benefit of Taiwan application Serial No. 102111496, filed Mar. 29, 2013, the subject matter of which is incorporated herein by reference.

### BACKGROUND OF THE INVENTION

1. Field of the Invention

The invention relates in general to a wireless communication system, and more particularly, to an automatic gain control (AGC) technology in a wireless signal receiver.

2. Description of the Related Art

A receiving end in a wireless local area network (WLAN) system requires capabilities for receiving signals in different strengths. In practice, a receiving end may encounter signals having a strength difference as high as 90 dB. A front-end automatic gain control (AGC) circuit in the receiving end is in charge of adjusting the amplitude of an input signal, so that the amplitude of the adjusted signal falls within a dynamic range of a subsequent analog-to-digital converter (ADC). In the event of improper operations of the AGC circuit, the amplitude of the signal provided to the ADC may be too large that the ADC becomes saturated or too small that the signal-to-noise ratio (SNR) becomes too low to affect the decoding accuracy.

In the prior art, the receiving end stores a constant initial gain. Each time before packet searching is conducted, the gain of the AGC circuit is reset to the initial gain. Starting from initial gain, the AGC circuit subsequently dynamically adjusts the gain according to the amplitude of the input signal. It can be understood that, as a difference between an appropriate gain for receiving a preamble of a packet and the initial gain gets larger, the time that the AGC circuit needs for determining the appropriate gain also increases.

Most AGC circuits are required to determine an appropriate gain within a predetermined time limit. Taking 802.11a/g/n specifications for example, the time limit is 8 μs, i.e., the length of a short preamble of a packet. In general, the strength of a signal received by a receiving end diminishes as the distance between a transmitting end and the receiving end increases. In practice, the distance between a receiving end (e.g., a laptop computer or a smart phone) and a transmitting end may not stay constant. In different circumstances, transmitting ends that provide communication connections may also vary. It is apparent that the constant initial gain is unfit for all kinds of wireless signal strengths. If a difference between the initial gain and a target gain gets too large that an AGC circuit becomes incapable of timely providing an appropriate gain, a receiving end may miss packets provided from a transmitting end (e.g., a wireless access point). With such occurrence, the receiving end may ask the transmitting end to again send packets with the same contents, thus degrading overall transmission efficiency of the system.

### SUMMARY OF THE INVENTION

The invention is directed to an automatic gain control (AGC) circuit, a wireless signal receiver including the AGC circuit, and an associated signal processing method. According to the AGC circuit, the wireless signal receiver and signal processing method of the present invention, an initial gain for the use of the AGC circuit is determined according to a beacon packet transmitted from a transmitting end. Such approach helps the AGC circuit to reduce the time required for determining an appropriate gain for packets subsequently transmitted from a same wireless access point. The concept of the present invention, in addition to a wireless communication system compliant to 802.11n specifications, is further applicable to all kinds of wireless communication systems that transmit beacon packets or similar reference signals.

According to an embodiment of the present invention, a wireless signal receiver is provided. The wireless signal receiver includes a receiving module, an AGC module, a measuring module, a decoding module and a control module. The receiving module receives a wireless signal. The AGC module adjusts an amplitude of the wireless signal according to a gain to generate an adjusted signal. The measuring module measures a signal strength of the adjusted signal. The decoding module decodes the adjusted signal. When the decoding module determines that the adjusted signal corresponds to a beacon packet transmitted from a transmitting end, the control module adjusts the gain according to the signal strength.

According to another embodiment of the present invention, an AGC circuit that dynamically adjusts a gain and adjusts an amplitude of a wireless signal received by a wireless signal receiver is provided. The AGC circuit includes an AGC module, a measuring module, a decoding module and a control module. The AGC module adjusts an amplitude of the wireless signal according to a gain to generate an adjusted signal. The measuring module measures a signal strength of the adjusted signal. The decoding module decodes the adjusted signal. When the decoding module determines that the adjusted signal corresponds to a beacon packet transmitted from a transmitting end, the control module adjusts the gain according to the signal strength.

According to yet another embodiment of the present invention, a signal processing method applied to a wireless signal receiver including an AGC module is provided. The signal processing method includes steps of: the AGC module adjusting an amplitude of the wireless signal according to a gain to generate an adjusted signal; measuring a signal strength of the adjusted signal; decoding the adjusted signal; and adjusting the gain according to the signal strength when the adjusted signal is determined as corresponding to a beacon packet transmitted from a transmitting end.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a wireless signal receiver according to an embodiment of the present invention; and

FIG. 2 is a flowchart of a signal processing method according to an embodiment of the present invention.

### DETAILED DESCRIPTION OF THE INVENTION

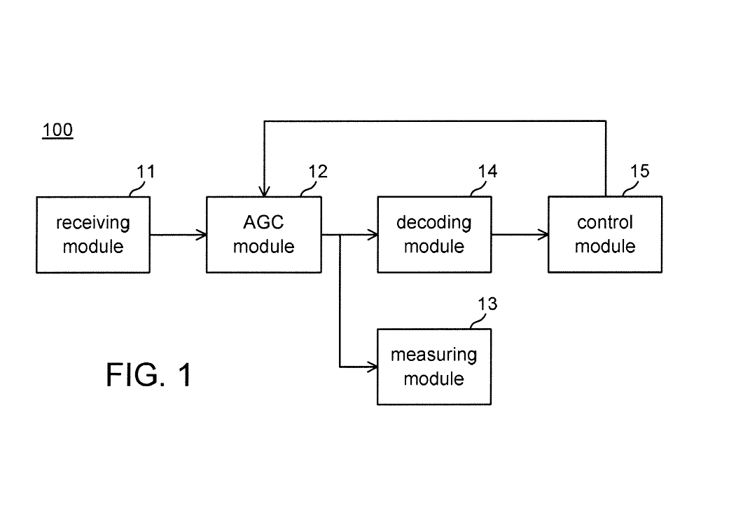

FIG. 1 shows a block diagram of a wireless signal receiver according to an embodiment of the present invention. A wireless signal receiver 100 includes a receiving module 11, an automatic gain control (AGC) module 12, a measuring module 13, a decoding module 14, and a control module 15. In practice, the wireless signal receiver 100 may be integrated in various kinds of electronic devices, e.g., desktop computers, laptop computers or smart phones, or may be an independent device.

Based on 802.11n specifications, a wireless access point needs to periodically broadcast beacon packets. The beacon packet carries information including a service set identifier (SSID), a media access control (MAC) address and a supported transmission rate for the reference of a receiving end to be connected to the wireless access point. Based on the signal strength of the beacon packet, the wireless signal receiver 100 determines an initial gain of the AGC module 12. With the description below, one person skilled in the art can easily appreciate that the concept of the present invention, in addition to a wireless communication system compliant to 802.11n specifications, is further applicable to all kinds of wireless communication systems that transmit beacon packets or similar reference signals.

The receiving module 11 receives a wireless signal and provides the wireless signal to the AGC module 12. In practice, for example, the receiving module 11 may be an antenna. The wireless signal receiver 100 stores a default gain G_{default}. The AGC module 12 adjusts the amplitude of the wireless signal according to the default gain G_{default} to generate an adjusted signal. The adjusted signal is transmitted to the measuring module 13 that measures the strength of the adjusted signal, and the decoding module 14 that decodes the adjusted signal. It should be noted that, details for measuring the signal strength and decoding the adjusted signal are well-known to one person skilled in the art, and shall be omitted herein.

In one embodiment, the measuring module 13 measures an average strength of the adjusted signal within a predetermined period, and regards the average strength as the signal strength. For example, the measuring module 13 may calculate the average strength according to the exponential moving average equation below:

E{RSSI[n]}=Coeff_avg*RSSI[n]+(1−Coeff_avg)*E{RSSI[n−1]}

In the above equation, RSSI[n] represents a latest set of sampling values of the signal strength, E{RSSI[n−1]} represents the average strength calculated without taking the latest sampling values of the signal strength into account, E{RSSI[n]} represents the average strength calculated by taking the latest sampling values of the signal strength into account, and Coeff_avg is an average parameter that is not limited to a specific value.

When the decoding module 14 correctly decodes the adjusted signal, and determines that the adjusted signal corresponds to one or multiple beacon packets transmitted from a transmitting end, the control module 15 determines an initial gain Gᵢₙᵢₜᵢₐₗ for the use of the AGC module 12 according to the signal strength E{RSSI[n]} generated by the measuring module 13. More specifically, as the AGC module 12 subsequently receives a new wireless signal, the AGC module 12 dynamically adjusts the gain of the newly received wireless signal according the amplitude of the input signal, starting from the initial gain Gᵢₙᵢₜᵢₐₗ. In one embodiment, the control module 14 calculates the initial gain Gᵢₙᵢₜᵢₐₗ according to an equation below:

Gᵢₙᵢₜᵢₐₗ[n]=RSSI_to_{—}Gᵢₙᵢₜᵢₐₗ(E{RSSI[n]})+offset

In the above equation, RSSI_to_Gᵢₙᵢₜᵢₐₗ ( ) represents a conversion function between the signal strength and the gain, and the parameter offset represents a correction value.

Unless the wireless signal receiver 100 is at a fast-moving state, the signal strengths of different kinds of packets received from the same wireless access point do not differ much. Therefore, by resetting the AGC module 12 according to the initial gain Gᵢₙᵢₜᵢₐₗ [n], it helps the AGC module 12 in reducing the time required for determining an appropriate gain for packets subsequently transmitted from the same wireless access point. As such, a possibility that the wireless signal receiver 100 misses packets caused by an inadequately low operation speed of the AGC module 12 can be significantly lowered, thereby enhancing overall transmission efficiency of a wireless system where the wireless signal receiver 100 is located.

In one embodiment, after the AGC module 12 is reset according to the initial gain Gᵢₙᵢₜᵢₐₗ [n], when the decoding module 14 does not obtain any decoded packet within a predetermined reset period, the control module 15 resets the AGC module 12 to adopt the default gain G_{default} as the initial gain, such that the wireless signal receiver 100 again starts searching for a new beacon packet and the corresponding new initial gain.

In one embodiment, the control module 15 periodically changes the initial gain adopted by the AGC module 12 according to a latest signal strength. More specifically, the measuring module 13 may be designed to continuously monitor the strength of the beacon packet, and the control module 15 may accordingly select the initial gain adopted by the AGC module 12 to dynamically and real-time determine an appropriate initial gain.

According to another embodiment of the present invention, an AGC circuit capable of dynamically adjusting a gain, configured to adjust an amplitude of a wireless signal received by a wireless signal receiver, is provided. The AGC circuit includes the AGC module 12, the measuring module 13, the decoding module 14 and the control module 15 shown in FIG. 1. The AGC circuit may be integrated into various kinds of wireless receivers, or may be an independent device. Operation details of the AGC circuit are as described in the foregoing embodiments, and shall be omitted herein.

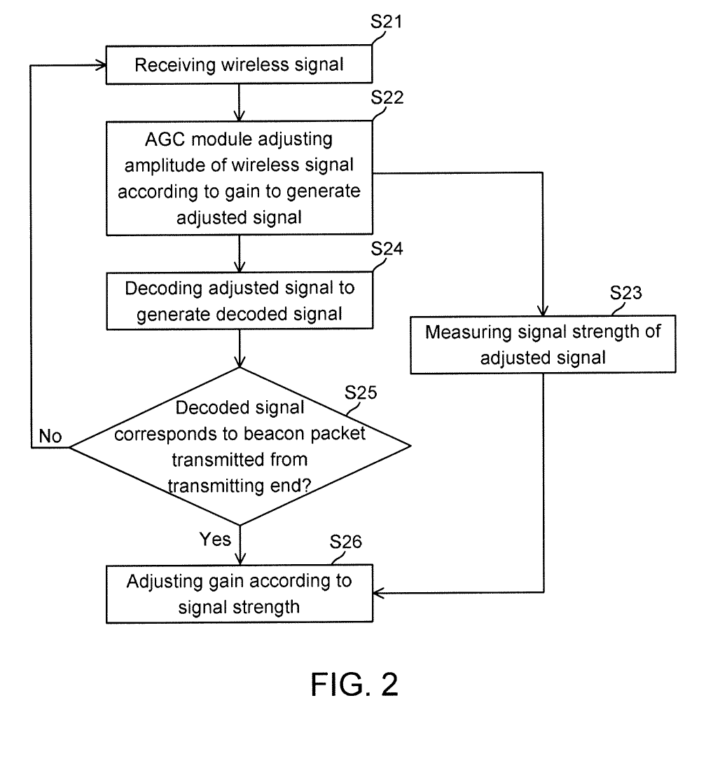

According to yet another embodiment of the present invention, a signal processing method applied to a wireless signal receiver is provided. Referring to FIG. 2 showing a flowchart of the signal processing method, the signal processing method includes the following steps. In step S21, a wireless signal is received. In step S22, the AGC module adjusts an amplitude of the wireless signal according to a gain to generate an adjusted signal. In step S23, a signal strength of the adjusted signal is measured. In step S24, the adjusted signal is decoded. In step S25, it is determined whether the decoded signal corresponds to one or multiple beacon packets transmitted from a transmitting end. When a determination result of step S25 is yes, step S26 is performed to adjust the gain according to the signal strength generated in step S23. When the result of step S25 is no, the process returns to step S21.

In practice, steps S21 to S26 can be periodically repeated. Further, various circuit operations described in association with the wireless signal receiver 100 are applicable to the signal processing method in FIG. 2, and shall be omitted herein.

As described, an AGC circuit, a wireless signal receiver including the AGC circuit and an associated signal processing method are disclosed by the present invention. According to the AGC circuit, the wireless signal receiver and the signal processing method of the present invention, an initial gain for the use of the AGC circuit is determined according to a beacon packet transmitted from a transmitting end. Such approach benefits the AGC circuit in reducing the time required for determining an appropriate gain for packets subsequently transmitted from a same wireless access point. The concept of the present invention, in addition to a wireless communication system compliant to 802.11n specifications, is further applicable to all kinds of wireless communication systems that transmit beacon packets or similar reference signals.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automatic gain control (AGC) circuit capable of dynamically adjusting a gain, configured to adjust an amplitude of a wireless signal received by a wireless signal receiver, comprising:
an AGC module, configured to adjust the amplitude of the wireless signal according to the gain to generate an adjusted signal;
a measuring module, configured to measure a signal strength of the adjusted signal;
a decoding module, configured to decode the adjusted signal; and
a control module, configured to adjust the gain according to the signal strength when the decoding module determines that the adjusted signal corresponds to a beacon packet transmitted from a transmitting end.

2. The AGC circuit according to claim 1, wherein the measuring module measures an average strength of the adjusted signal within a predetermined period, and regards the average strength as the signal strength.

3. The AGC circuit according to claim 2, wherein the measuring module calculates the average strength by an exponential moving average procedure.

4. The AGC circuit according to claim 1, wherein the transmitting end periodically transmits the beacon packet, and the control module periodically adjusts the gain according to the signal strength.

5. The AGC circuit according to claim 4, wherein the control module resets the gain to a predetermined gain when the decoding module does not obtain any packet from decoding the adjusted signal within a predetermined reset period.

6. A wireless signal receiver, comprising:
a receiving module, configured to receive a wireless signal;
an AGC module, configured to adjust an amplitude of the wireless signal according to a gain to generate an adjusted signal;
a measuring module, configured to measure a signal strength of the adjusted signal;
a decoding module, configured to decode the adjusted signal; and
a control module, configured to adjust the gain according to the signal strength when the decoding module determines that the adjusted signal corresponds to a beacon packet transmitted from a transmitting end.

7. The wireless signal receiver according to claim 6, wherein the measuring module measures an average strength of the adjusted signal within a predetermined period, and regards the average strength as the signal strength.

8. The wireless signal receiver according to claim 7, wherein the measuring module calculates the average strength by an exponential moving average procedure.

9. The wireless signal receiver according to claim 6, wherein the transmitting end periodically transmits the beacon packet, and the control module periodically adjusts the gain according to the signal strength.

10. The wireless signal receiver according to claim 9, wherein the control module resets the gain to a predetermined gain when the decoding module does not obtain any packet from decoding the adjusted signal within a predetermined reset period.

11. A signal processing method, applied to a wireless signal receiver comprising an AGC module, comprising:
a) receiving a wireless signal;
b) the AGC module adjusting an amplitude of the wireless signal according to a gain to generate an adjusted signal;
c) measuring a signal strength of the adjusted signal;
d) decoding the adjusted signal to generate a decoded signal; and
e) adjusting the gain according to the signal strength when the decoded signal is determined as corresponding to a beacon packet transmitted from a transmitting end.

12. The signal processing method according to claim 11, wherein step (c) comprises measuring an average strength of the adjusted signal within a predetermined period and regarding the average strength as the signal strength.

13. The signal processing method according to claim 12, wherein step (c) comprises calculating the average strength by an exponential moving average procedure.

14. The signal processing method according to claim 11, further comprising:
periodically adjusting the gain according to the signal strength.

15. The signal processing method according to claim 14, further comprising:
resetting the gain to a predetermined gain when the wireless signal receiver does not obtain any decoded packet from the decoded signal within a predetermined reset period.
